(19) United States
(12) Patent Application Publication
(10) Pub. No.: US 2010/0110879 A1
(43) Pub. Date: May 6, 2010

(54) METHOD AND APPARATUS FOR PROVIDING MULTIMEDIA BROADCAST MULTICAST SERVICE

(76) Inventors: Jung-Im KIM, Daejeon (KR); Chul Sik Yoon, Seoul (KR); Jee Hwan Ahn, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/609,152

(22) Filed: Oct. 30, 2009

(30) Foreign Application Priority Data
Oct. 31, 2008 (KR) 10-2008-0108044
Aug. 25, 2009 (KR) 10-2009-0078801

(51) Int. Cl. H04W 72/04; G06F 11/08

(52) U.S. Cl. 370/216; 370/329

(57) ABSTRACT

Provided are a method and an apparatus for providing a multimedia broadcast multicast service. The method for providing a multimedia broadcast multicast service (MBMS) in a base station includes determining the number of terminals receiving the MBMS and determining a unit-cell or multi-cell transmission scheme by comparing predetermined unit-cell and multi-cell thresholds with the determined number of terminals.

### CROSS-REFERENCE TO RELATED APPLICATION

This application claims priority to and the benefit of Korean Patent Application Nos. 10-2008-0108044 and 10-2009-0078801 filed in the Korean Intellectual Property Office on Oct. 31, 2008 and Aug. 25, 2009, the entire contents of which are incorporated herein by reference.

### BACKGROUND OF THE INVENTION

(a) Field of the Invention

The present invention relates to a method and an apparatus for providing a multimedia broadcast multicast service. More particularly, the present invention relates to a method and an apparatus for providing transmission, feedback, notification, and multiplexing of a multimedia broadcast multicast service.

(b) Description of the Related Art

A data transmission service in the known mobile communication system can be classified into a multimedia broadcast multicast service and a unitcast service.

In the case of the unicast service, terminals perform the service by using different radio resources, and in the case of the broadcast multicast service, a plurality of terminals perform the service by using the same radio resource to perform a service having higher efficiency of the radio resource. Herein, the broadcast multicast service is referred to as a multimedia broadcast multicast service (MBMS) in the case of a 3^{rd} generation partnership project (3GPP), and a multicast broadcast service (MBS) in the case of IEEE 802.16.

In general, a signal passing through a radio channel may have various errors due to fading and an interference signal of the radio channel. In the mobile communication system, examples of a scheme to correct an error may generally include an automatic repeat request (ARQ) scheme, a forward error correction scheme, and a hybrid automatic repeat request (HARQ) scheme that combines the ARQ scheme and the forward error correction scheme.

Herein, the HARQ scheme improves an error correction ability by simultaneously operating the retransmission and forward error correction of a physical layer. That is, the HARQ scheme does not waste previous data packets having errors, and inputs the previous data into an error correction decoder at the time of decoding a subsequently retransmitted data packet to improve the error correction ability. In general, since the errors are generated in only some of the packets, a packet having an error is not wasted and is inputted into the decoder so as to improve the error correction ability.

Meanwhile, the amount of data that should be stored is remarkably increased in order to use the forward error correction of the physical layer. In this case, the HARQ scheme very rapidly reports generation of errors of the data through a feedback channel and rapidly receives retransmission in order to reduce the amount of data that should be stored.

However, the known 3GPP WCDMA MBMS service does not perform the HARQ scheme and uses a HARQ scheme allocating a unique feedback channel to each terminal when the MBMS service is transmitted only by the unit of a unit cell in a long term evolution (LTE) system.

Therefore, in the case of an LTE MBMS unit-cell service, since the feedback channel performs the feedback in both a case in which the terminal has an error and a case in which the terminal does not have an error, the feedback amount is increased such that the feedback channel cannot be allocated to many terminals because of limited resources.

In addition, in the case of the IEEE 802.16e MBS service, a scheme to perform retransmission in the physical layer without a feedback allocation resource to the terminal is performed. By retransmitting all data without using the feedback channel, unnecessary retransmission is performed even when there is no terminal having an error.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for providing a service that determines a transmission scheme having an advantage of maximizing the efficiency of a radio resource in accordance with the number of terminals at the time of performing a broadcast multicast service.

Further, the present invention has been made in an effort to provide a method and an apparatus for providing a multimedia broadcast multicast service having an advantage of preventing unnecessary transmission and retransmission of data by checking a case in which there is no terminal receiving a service after the service is started and controlling an interference amount due to feedback overhead.

An exemplary embodiment of the present invention provides a method for providing a multimedia broadcast multicast service (MBMS) in a base station that includes determining the number of terminals receiving the MBMS; and determining a unit-cell or multi-cell transmission scheme by comparing predetermined unit-cell and multi-cell thresholds with the determined number of terminals.

Herein, the determining of the number of terminals includes requesting a reception intention for the MBMS to the terminal through a broadcast channel, and receiving the reception intention for MBMS through a feedback channel allocated to the terminal.

In addition, the determining of a unit-cell or multi-cell transmission scheme includes determining the transmission scheme as the unit-cell transmission scheme when the number of terminals is smaller than the threshold, and allocating a common feedback channel for the unit cell through a control channel.

In contrast, the determining of a unit-cell or multi-cell transmission scheme additionally includes determining the transmission scheme as the multi-cell transmission cell when the number of terminals is larger than the threshold, and allocating the common feedback channel to each cell when the number of terminals in each cell is not larger than a predetermined frequency to use the feedback channel.

Another embodiment of the present invention provides an apparatus for providing a multimedia broadcast multicast service (MBMS) that includes a communication unit determining the number of terminals by receiving the MBMS, and a control unit determining a unit-cell or multi-cell transmission scheme by comparing predetermined unit-cell and multi-cell thresholds with the determined number of terminals.

Herein, the communication unit requests a reception intention for each MBMS through a broadcast channel and receives the reception intention through a feedback channel allocated to the terminal

The control unit uses at least one of a control channel for notifying at least one of an identifier for each MBMS, data transmission time information, and positional information of a radio resource, a notice channel for determining the number of terminals or notifying a change of a predetermined notice, and a feedback channel for receiving feedback from the terminal.

In addition, the control unit determines a transmission scheme as the unit-cell transmission scheme when the number of terminals is smaller than the threshold, or determines the transmission scheme as the multi-cell transmission scheme when the number of terminals is larger than the threshold.

Further, the control unit retransmits data the predetermined number of times without allocating the common feedback channel when the number of terminals in each cell is larger than a frequency to use the feedback channel.

### BRIEF DESCRIPTION OF THE DRAWINGS

FIG. 1 is a diagram illustrating a configuration of a network for providing an MBMS service according to an embodiment of the present invention;

FIG. 2 illustrates a multimedia broadcast multicast transmission method for each case depending on the number of terminals according to an embodiment of the present invention;

FIG. 3 is a flowchart illustrating a method for transmitting a unit cell according to a first embodiment of the present invention;

FIG. 4 is a flowchart illustrating a method for transmitting multiple cells according to a second embodiment of the present invention; and

FIG. 5 is a flowchart illustrating a method for transmitting multiple cells according to a third embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a terminal may designate a mobile station (MS), a terminal, a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In the specification, a base station (BS) may designate an access point (AP), a radio access station (RAS), node B, a base transceiver station (BTS), a mobile multihop relay (MMR)-BS, etc., and may include the entire or partial functions of the access point, the radio access station, the node B, the base transceiver station, the MMR-BS, etc.

Hereinafter, a method and an apparatus for providing a multimedia broadcast multicast service according to an embodiment of the present invention will be described in detail with reference to the accompanying drawings.

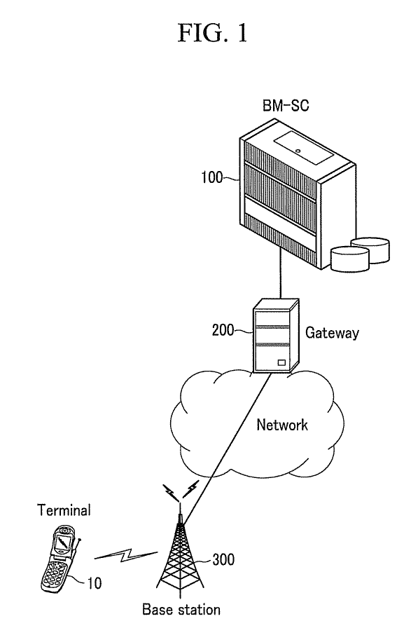

FIG. 1 is a diagram illustrating a configuration of a network for providing an MBMS service according to an embodiment of the present invention.

Referring to FIG. 1, the network for providing the MBMS service according to the embodiment of the present invention includes an MBMS service center (BM-SC) 100 providing the MBMS service, a gateway 200 that is connected to the BM-SC and supports multicast and unicast services, a base station 300, and a terminal 10.

In general, the BM-SC 100 which is the MBMS service center is loaded with a real time protocol (RTP) which is a real-time processing protocol and a user datagram protocol (UDP). The RTP includes an error correction encoder and the UDP includes a UDP checksum generator.

Wireless interface protocols of the base station 300 and the terminal 10 are horizontally composed of a physical layer, a data link layer, and a network layer, and are vertically classified into a user plane for transmitting data information and a control plane for transmitting a control signal. The protocol layers can be classified into a first layer L1, a second layer L2, and a third layer L3 on the basis of three lower layers of an open system interconnection (OSI) standard model that is widely known in a communication system.

A physical layer as the first layer provides an information transfer service to an upper layer by using a physical channel. The physical layer is connected with a medium access control (MAC) layer which is an upper layer, through a transmit channel. Data is transmitted between the medium access control layer and the physical layer through the transmit channel.

The medium access control (MAC) layer of the second layer provides a service to a radio link control (RLC) layer which is the upper layer, through a logical channel. The radio link control (RLC) layer of the second layer can support reliable transmission of data, and can perform segmentation and concatenation functions with an RLC service data unit that comes from the upper layer.

A radio resource control (RRC) layer positioned in the lowest part of the third layer is defined only on a control plane, and takes charge of controlling logical channels, transmit channels, and physical channels in relation to configuration, re-configuration, and release of radio bearers.

The base station 300 includes a communication unit that determines the number of terminals 10 receiving the MBMS service, and a control unit that determines a unit-cell or multi-cell transmit scheme depending on the determined number of terminals 10.

The communication unit notifies the position of a control channel of the multimedia broadcast multicast service to a broadcast channel of the system in order to count the number of terminals 10 before starting the service. The communication unit inquires of the terminal 10 whether or not to receive the service through the control channel, and determines the number of terminals 10 in response to the inquiry. At this time, the control channel includes at least one of identifier information for each service, the position of a radio resource of a feedback channel, and information on transmission timing of a notice channel. Herein, the notification channel serves to determine the number of terminals 10 or notify a change of a specific notice, and the feedback channel represents the channel for receiving a feedback from the terminal 10.

The control unit serves to control general operations and functions of the base station 300, and determines the unit-cell or multi-cell transmission scheme depending on the number of terminals 10 determined by the communication unit. In addition, when a frequency to use the feedback, which is anticipated depending on the number of terminals 10 for each cell, is more than a predetermined threshold, the control unit controls all cells of the multi-cell to not perform the feedback, and when the frequency is not more than the threshold, the control unit controls all the cells to perform the feedback.

The control unit allows retransmission to be performed for each cell by allocating a common feedback channel to each cell in the multi-cell transmission scheme, and allows the multiple cells to perform retransmission at the same time when the feedback channel is not allocated.

The terminal 10 receives the control channel by acquiring positional information of the multimedia broadcast multicast service control channel in the broadcast channel of the system when the terminal 10 intends to receive the service. In addition, the terminal 10 performs the response through the feedback channel allocated to the notice channel inquiring whether or not to receive the service.

The base station 300 and the network can determine the number of terminals 10 by repeatedly performing the notification, and can determine the service transmission scheme by considering the number.

MBMS service data passes through the gateway 200 and is transmitted to the terminal 10 through the base station 300 in accordance with the response of receiving the service. The physical layer of the terminal 10 receives and decodes the data passing through the radio channel, and thereafter performs a cyclic redundancy check (CRC) for the data.

That is, the physical layer of the terminal 10 determines whether or not a data packet has an error by performing channel decoding and performing the CRC, and transmits the result of the CRC to the base station 300.

According to the embodiment of the present invention, a part of an L1/L2 control channel is used as the multimedia broadcast multicast service notification channel. Herein, the notification can be used when the service is started, a specific content of the service control channel is changed, or a response for verifying the existence of the terminal receiving the service is required.

More specifically, in a mobile communication system, the terminal 10 is operated by dividing the state of the terminal 10 into a connected state or an idle state in order to reduce power consumption.

When the terminal 10 is in the connected state, the terminal 10 is connected to the base station 300 to receive the unicast service, and when the terminal 10 is in the idle state, the terminal 10 does not receive the unicast service such that the terminal 10 cyclically verifies whether or not to receive system information and paging in the state where power consumption is small.

In contrast, the terminal 10 can receive the multimedia broadcast multicast service in both the connected state and the idle state. Therefore, in the case of the broadcast multicast service, the terminal 10 transmits data to the control channel in a manner to reduce the power consumption of the terminal 10 in the idle state. Therefore, the terminal 10 is generally in the idle state during much of the time.

In the case of the unitcast service, the base station 300 transmits information including identifier information of the terminals 10 through the L1/L2 control channel to the terminals 10. Therefore, the terminal 10 verifies a service chance of the terminal 10 by reading the control channel, and transmits and receives data. Further, since the L1/L2 control channel transmits the paging information to the terminal 10 in the idle state, the terminal 10 in the idle state cyclically receive L1/L2 control information. The L1/L2 control channel can be rapidly processed in the physical layer of the terminal 10.

However, in the case of the known 3GPP WCDMA and IEEE 802.16e multimedia broadcast multicast service, the control information is not transmitted through the L1/L2 control channel received by the physical layer but through the multimedia broadcast multicast control channel. Accordingly, the terminal 10 acquires data receiving time information (scheduling information) through the multimedia broadcast multicast control channel.

At this time, the multimedia broadcast multicast control channel as a channel that is not rapidly processed in the physical layer processes a signal in a higher protocol than the MAC layer. That is, since the known scheme does not include a HARQ scheme with the feedback, the known scheme does not require rapid processing in the physical layer.

However, according to the embodiment of the present invention, since a HARQ scheme with the feedback is used, the L1/L2 control channel can be used during retransmission. Further, the L1/12 control channel is used for the known purpose.

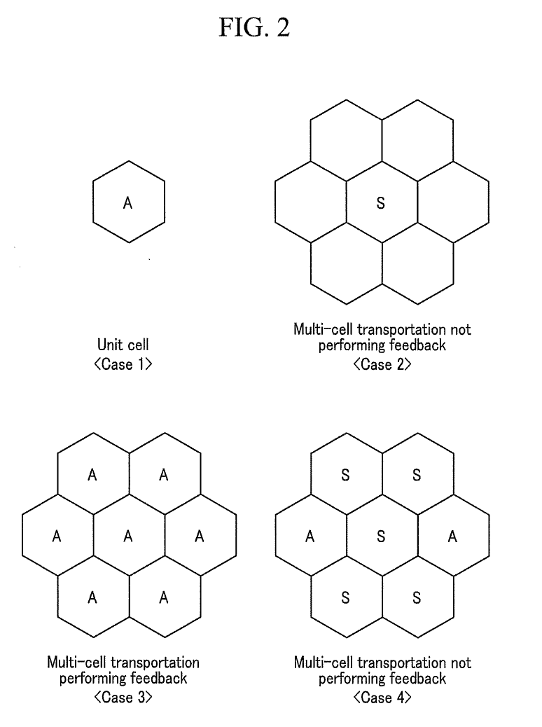

A multimedia broadcast multicast transmission method depending on the number of terminals according to an embodiment of the present invention will now be described with reference to FIGS. 2 to 5.

FIG. 2 illustrates a multimedia broadcast multicast transmission method for each case depending on the number of terminals according to an embodiment of the present invention.

Referring to FIG. 2, Case 1 represents a case of unit cell transmission, Case 3 represents a case of multi-cell transmission performing the feedback, and each of Case 2 and Case 3 represents a case of multi-cell transmission not performing feedback.

Herein, “A” and “S” represent the determined number of terminals 10 in the cell. “A”, which is the number of terminals 10, represents a smaller value than predetermined unit-cell and multi-cell thresholds, and “S”, which is the number of terminals 10, represents a larger value than the predetermined unit-cell and multi-cell thresholds.

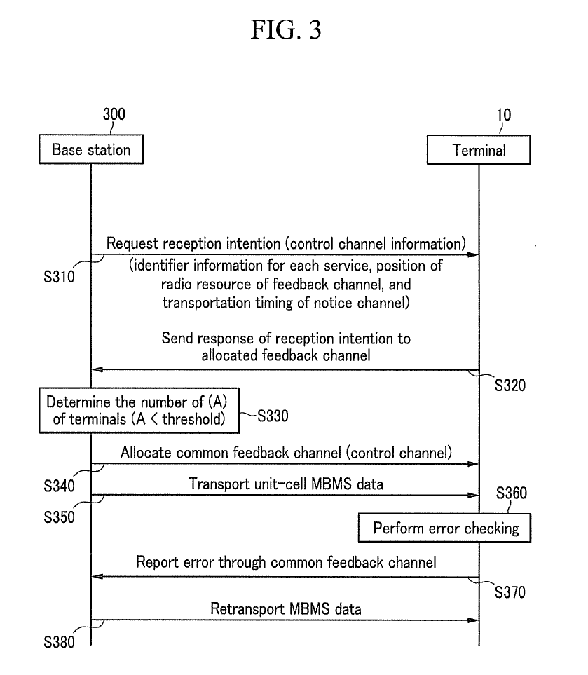

First. FIG. 3 is a flowchart illustrating a method for transmitting a unit cell according to a first embodiment of the present invention.

Referring to FIG. 3, the method for transmitting the unit cell according to the first embodiment of the present invention is described by assuming the case of Case 1 of FIG. 2.

The base station 300 requests a reception intention for each MBMS service through the broadcast channel of the system in order to determine the number of terminals 10 before starting the MBMS service or in process of the service (S310).

When there is a service reception intention, the terminal 10 acquires the positional information of the control channel in the broadcast channel and responds to the service reception intention through the allocated feedback channel (S320).

The base station 300 determines the number (A) of terminals 10 that is verified by the response of the reception intention, and since the determined number A of terminals 10 is smaller than the predetermined unit-cell and multi-cell thresholds, the transmission method is determined as the unit-cell transmission method (S330). In addition, the base station 300 allocates a common feedback channel to the unit cell through the control channel (S340), and transmits the unit cell MBMS service data through the transmission channel (S350).

The terminal 10 determines whether or not the data packet has an error by performing the CRC after decoding the received service data (S360). In addition, as the CRC result, when the data packet has an error, error reporting is performed through the common feedback channel (S370).

The base station 300 retransmits the corresponding MBMS data in accordance with the error reporting of the terminal 10 (S380). Herein, the retransmission of the MBMS data represents retransmitting the already transmitted data in order to correct the error generated by a harsh environment of the radio channel, etc. For example, the retransmission of the MBMS data can include the hybrid automatic repeat request (HARQ) scheme.

According to the embodiment of the present invention, it is preferable that the base station 300 does not transmit the service data by a multiplexing scheme when a plurality of multimedia broadcast multicast services are provided in the cell during the unit-cell transmission. The reason for this is that when the service data is multiplexed, the error reporting is performed to the common feedback channel even for the error of the service data that the terminal 10 does not want to receive, such that unnecessary retransmission can be induced.

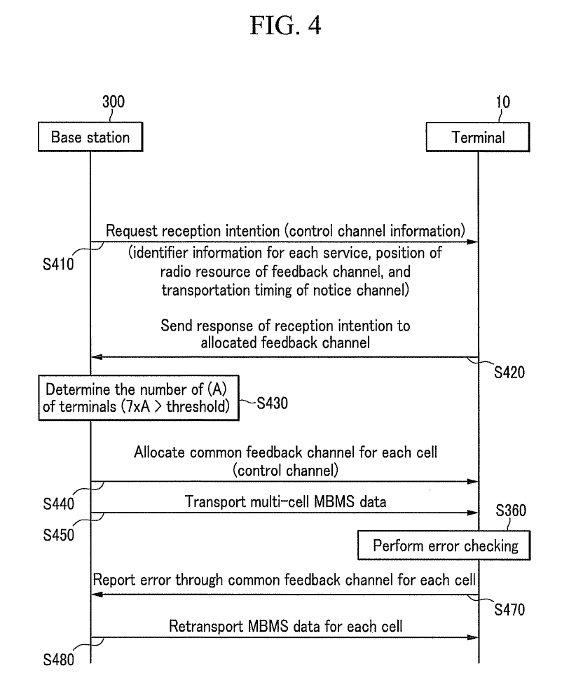

Next. FIG. 4 is a flowchart illustrating a method for transmitting multiple cells according to a second embodiment of the present invention.

Referring to FIG. 4, the method for transmitting the multi-cells according to the second embodiment of the present invention is described by assuming the case of Case 3 of FIG. 2. Since steps S410 and S420 that are the process for the base station 300 to determine the number of terminals 10 are similar to the steps of FIG. 1, a description thereof will be omitted.

The base station 300 determines the number of terminals 10 that is verified by the response of the reception intention, and since the determined number A of terminals 10 is larger than the predetermined unit-cell and multi-cell thresholds, the transmission method is determined as the multi-cell transmission method (S430). At this time, although the number A of terminals 10 in one cell is smaller than the predetermined unit-cell and multi-cell thresholds, the total number 7*A of terminals in seven cells is larger than the predetermined unit-cell and multi-cell thresholds, such that the multi-cell service is performed.

In addition, the base station 300 anticipates that the number A of terminals 10 in each cell is smaller than a predetermined frequency to use the feedback channel, and thus allocates the common feedback channel to the terminal 10 for each cell (S440) and transmits the multi-cell MBMS service data through the transmission channel (S450).

The terminal 10 determines whether or not the data packet has an error by performing the CRC after decoding the received service data (S460). In addition, as the CRC result, when the data packet has an error, error reporting is performed through the common feedback channel for each cell (S470).

The base station 300 retransmits the corresponding MBMS data in accordance with the received error reporting of the terminal 10 (S480).

According to the embodiment of the present invention, it is preferable that the base station 300 does not transmit the service data by multiplexing in order to prevent unnecessary retransmission when a plurality of multimedia broadcast multicast services are transmitted in the cell during the multi-cell transmission performing the common feedback, like Case 3.

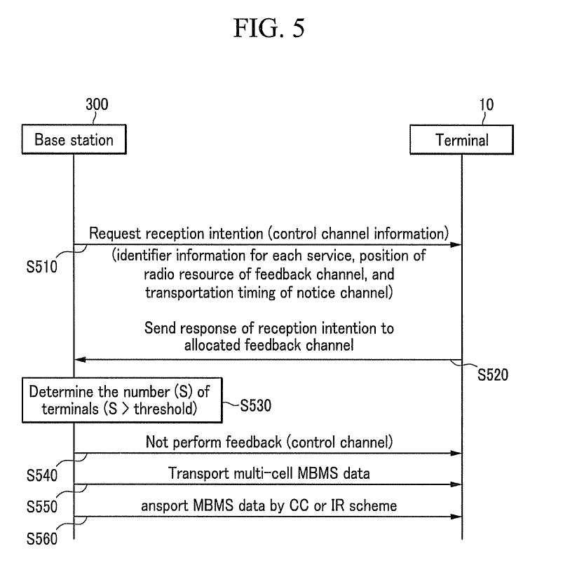

Next, FIG. 5 is a flowchart illustrating a method for transmitting multiple cells according to a third embodiment of the present invention.

Referring to FIG. 5, the method for transmitting the multi-cells according to the third embodiment of the present invention is described by assuming the cases of Case 2 and 4 of FIG. 2. Since steps S510 and S520 that are the process for the base station 300 to determine the number of terminals 10 are similar to the steps of FIG. 1, a description thereof will be omitted.

The base station 300 determines the number of terminals 10 verified by the response of the reception intention, and when the number S of terminals 10 in one or more unit cells is larger than the predetermined unit-cell and multi-cell threshold, the transmission method is determined as the multi-cell transmission method (S530). Herein, the number S of terminals 10 represents a value that is larger than the predetermined unit-cell and multi-cell thresholds.

Subsequently, the base station 300 anticipates that the anticipated feedback frequency is larger than the predetermined frequency, so it stops the terminal 10 from performing the error reporting to the common feedback channel. That is, the base station 300 does not allocate the common feedback (S540), and transmits the multi-cell MBMS service data through the transmission channel (S550).

The base station 300 retransmits data to all MBMS data of the multi cells by a chase combining (CC) or incremental redundancy (IR) scheme a predetermined number of times (S560) in the case of Case 2 and Case 4. At this time, in the case of the retransmission, the multi-cells are transmitted at the same time so as to acquire a diversity gain. Herein, at the time of retransmitting the data, the IR scheme is a scheme to transmit the data by adding a new parity bit to the retransmitted data and in order to acquire more gains of channel coding. The CC scheme is a scheme to transmit the same retransmitted data as the previously transmitted data.

Meanwhile, it is preferable that the base station 300 multiplexes and transmits a plurality of services in order to prevent unnecessary retransmission when the plurality of multimedia broadcast multicast services are transmitted in the cell during the multi-cell transmission not performing the common feedback. At this time, the base station 300 can transmit the plurality of services with different traffic sizes depending on time. The reason for this is that, for example, when the multiplexing is not performed, the radio resource without data is transmitted is generated in the case where the traffic is small to not fill a radio resource space, thereby wasting the resources. Therefore, the multiplexing at the time of transmitting the plurality of services has an advantage of reducing waste of the radio resources.

In the multi-cell transmission scheme using the common feedback channel, the feedback channel is allocated to each cell and retransmission can be performed for each cell. In the scheme to retransmit all the multi-cells at the same time, it may take time to collect and process information on the feedback channel allocated to each cell in order to determine whether or not to retransmit the multi-cells at the same time, and complexity of processing the feedback may be increased. Accordingly, the scheme to perform the retransmission for each cell has an advantage of reducing the complexity of the system and a data receiving time. In addition, the multi-cell transmission without the terminal 10 having an error in the cell has an advantage of using the radio resource to transmit other data.

Meanwhile, according to the embodiment of the present invention, when the terminal 10 receiving the broadcast multicast service is not provided, a 3GPP MBMS service performs counting and recounting in order to prevent unnecessary data transmission.

Herein, as described above, the counting represents counting the number of terminals 10 before starting the service, and the recounting represents counting the number of terminals 10 while performing the service.

The base station 300 determines the number of terminals 10 receiving the broadcast multicast service through the counting and recounting processes, and determines how to perform the service. That is, during the counting and recounting processes, the terminal 10 sends a response when the terminal 10 intends to receive the broadcast multicast service to the base station 300. At this time, the terminal 10 performs the response by being allocated with the radio resource or using the already allocated radio resource in the connected state. In contrast, when the terminal 10 is in the idle state, the terminal can perform the response by using the radio access channel.

In the case of the common feedback channel, a scheme in which the feedback channel is allocated to each of the terminals in the connected state and in the idle state depending on whether the terminal 10 is in the connected state or in the idle state is proposed.

The terminal 10 in the connected state has the already allocated feedback channel. For example, when the terminal 10 has the already allocated feedback channel for the unitcast service, the terminal uses the channel at it is.

In contrast, the terminal 10 in the idle state has no allocated feedback. The terminal 10 in the idle state uses some of the unitcast feedback channel that the terminals 10 in the connected state can use as the common feedback channel. That is, the terminal 10 in the idle state can allocate and use some of the IEEE 802.16 ranging channel which is the 3GPP random access channel as the common channel.

At this time, since the size of the feedback channel in the connected state is smaller than the size of the feedback of the terminal 10 in the idle state, the terminal 10 in the connected state preferentially transmits the feedback to minimize system uplink interference when both the terminals 10 in the connected state and the idle state have an error. That is, the present invention grants a feedback preference to the terminal in the connected state when both the terminals 10 in the connected state and in the idle state have an error.

In addition, when the base station 300 receives the feedback from the terminal 10 in the connected state and notifies the position of the retransmitted data to the L1/L2 control channel, the terminal 10 in the idle state has an advantage of receiving the retransmitted data without transmitting the feedback.

Meanwhile, the base station 300 reports the error through the common feedback channel that notifies whether or not the multimedia broadcast multicast service data is retransmitted to a predetermined radio resource by using the L1/L2 control channel to the terminal 10. At this time, the base station 300 can transmit the L1/L2 control channel by a synchronous HARQ scheme within a predetermined time. Herein, the reason for transmitting the L1/L2 control channel within the predetermined time is to minimize power consumption of the terminal 10 in the idle state.

After the service is started, the base station 300 or the network verifies whether or not the terminal receiving the service is provided through the common feedback channel. When the error reporting is not performed for a predetermined time due to a good state of the radio channels of all the terminals 10, the L1/L2 control channel allocated to the multimedia broadcast multicast notice channel is transmitted to allow the terminal 10 to perform the response through the common channel.

Herein, the base station 300 or the network allows the terminal 10 to perform the response by using the common feedback channel in accordance with a random probability by granting a random probability value to the terminal 10 in order to prevent large interference to adjacent cells due to simultaneous response of multiple terminals 10. At this time, the notice channel for the multimedia broadcast multicast service is transmitted to the L1/L2 control channel, and a scheme in which an identifier for each service is allocated and the notice channel is transmitted only at a predetermined time is used. The reason for using the notice channel only at the predetermined time is to minimize the power of the terminal 10 at the time of reading the notice channel when the terminal 10 is in the idle state.

Meanwhile, a plurality of operators (operator or carrier) are provided in the adjacent cells, such that when the operators provide different services at different frequencies, the operators allows the service to be used by a terminal 10 that does not subscribe in the corresponding operator. In this case, when the terminal 10 wants to receive the service not provided by the subscribed operator, the terminal 10 needs required frequency and parameter information to receive the corresponding service.

Herein, shifting to another frequency by receiving the service provided from the operator in which a terminal 10 does not subscribe is referred to as frequency layer convergence, and a terminal 10 returning to the frequency of the subscribed after the service is terminated is referred to as frequency layer dispersion.

In general, a 3GPP WCDMA system does not use the L1/L2 control channel at the time of performing the frequency layer convergence and the frequency layer dispersion.

However, the system according to the embodiment of the present invention proposes a method of using the L1/L2 control channel for a known purpose at the time of performing the frequency layer convergence and the frequency layer dispersion.

For example, when a cell not of the first operator in which the terminal 10 subscribes does not provide the service that the terminal 10 wants to receive, but the second operator in which the terminal does not subscribe provides the service, the terminal 10 is notified that the other second operator performs its desired service through the L1/L2 control channel in the cell of the first operator and receives the service at another frequency.

Next, after the desired service is terminated, the terminal 10 receives a notice to return to the first operator cell from the L1/L2 control channel provided by the second operator cell from which the terminal 10 receives the service to return to the subscribed first operator cell.

In general, in the unicast service, the terminal 10 reports the termination of the service to the base station 300 and the network. This is a procedure for the base station 300 and the network to receive the radio resource and identifier and provide them to another terminal.

The multimedia broadcast multicast service according to the embodiment of the present invention proposes a scheme to not report the termination of a service when the terminal 10 terminates the service. The reason for this is in that when a small number of terminals 10 report the termination of the service, few radio resources required for reporting are consumed, but when a large number of terminals 10 report the termination of the service, much radio resources are consumed.

As described above, according to an embodiment of the present invention, the present invention has an advantage of preventing unnecessary transmission by transmitting a plurality of services with different traffic sizes according to a time at the time of transmitting a plurality of multimedia broadcast multicast services in a cell during multi-cell transmission not performing common feedback.

In addition, according to the embodiment of the present invention, since the multimedia broadcast multicast service uses a HARQ scheme with feedback, it is possible to rapidly process data in a physical layer of a terminal 10 by using an L1/L2 control channel for retransmission and the known purpose, and a terminal 10 in the idle state can receive the retransmitted data without transmitting the feedback.

Further, the present invention has an advantage of preventing unnecessary transmission and retransmission of data by checking a case in which the terminal 10 receiving the service is not provided after starting an MBMS service and controlling an interference amount due to feedback overhead.

According to the embodiments of the present invention, the present invention has an advantage of preventing unnecessary transmission by transmitting a plurality of services with different traffic sizes according to a time at the time of transmitting a plurality of multimedia broadcast multicast services in a cell during multi-cell transmission not performing a common feedback.

In addition, according to an embodiment of the present invention, since the multimedia broadcast multicast service uses a HARQ scheme with feedback, it is possible to rapidly process data in a physical layer of a terminal by using an L1/L2 control channel for retransmission and the known purpose, and a terminal in the idle state can receive the retransmitted data without transmitting the feedback.

Further, the present invention has an advantage of preventing unnecessary transmission and retransmission of data by checking a case in which the terminal receiving the service is not provided after starting an MBMS service and controlling an interference amount due to feedback overhead.

The above-mentioned exemplary embodiments of the present invention are not embodied only by an apparatus and/or method. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for providing a multimedia broadcast multicast service (MBMS) in a base station, comprising:
determining the number of terminals receiving the MBMS; and
determining a unit-cell or multi-cell transmission scheme by comparing predetermined unit-cell and multi-cell thresholds with the determined number of terminals.

2. The method of claim 1, wherein
the determining of the number of terminals includes:
requesting a reception intention for the MBMS to the terminal through a broadcast channel; and
receiving the reception intention for MBMS through a feedback channel allocated to the terminal.

3. The method of claim 1, wherein
the determining of a unit-cell or multi-cell transmission scheme includes:
determining the unit-cell transmission scheme as a transmission scheme when the number of terminals is smaller than the threshold; and
allocating a common feedback channel for the unit cell through a control channel.

4. The method of claim 1, wherein
the determining of a unit-cell or multi-cell transmission scheme includes:
determining the multi-cell transmission cell as a transmission scheme when the number of terminals is larger than the threshold; and
allocating a common feedback channel to each cell when the number of terminals in each cell is not larger than a predetermined frequency to use the feedback channel.

5. The method of claim 1, further comprising,
after the determining of a unit-cell or multi-cell transmission scheme:
receiving error reporting through the common feedback channel allocated to the terminal after the MBMS is started; and
performing data retransmission by the error reporting to the terminal.

6. The method of claim 4, wherein,
while the common feedback channel is not allocated when the number of terminals in each cell is larger than the frequency to use the feedback channel,
multi-cells retransmit data at the same time by the predetermined number of times so as to acquire a diversity gain of the multi-cell transmission.

7. The method of claim 5, further comprising:
allocating an identifier and a random probability value for each service by using an L1/L2 control channel as a notice channel for the MBMS when the error reporting is not provided from the terminal for a predetermined time; and
receiving a response through the common feedback channel in accordance with the random probability value from the terminal.

8. The method of claim 7, wherein
the random probability value
is transmitted through the control channel and the notice channel is transmitted only at a predetermined time.

9. The method of claim 5, further comprising,
notifying a retransmission time by receiving the feedback channel and transmitting it at a predetermined time,
wherein at least one of the position of a radio resource of the retransmitted data and a hybrid automatic repeat request (HARQ) variable is transmitted to the L1/L2 control channel.

10. The method of claim 6, wherein
the retransmission performs the HARQ by using the feedback channel,
the MBMS is not multiplexed when the common feedback channel is used, or
the multiplexing is performed when the common feedback channel is not used.

11. The method of claim 10, wherein
the HARQ
grants a feedback preference to a first terminal in a connected state and allows a second terminal in an idle state to receive the retransmitted data without performing the feedback.

12. The method of claim 7, wherein
the L1/L2 control channel
is used to notify at least one of a frequency layer convergence operation and a frequency layer dispersion operation.

13. An apparatus for providing a multimedia broadcast multicast service (MBMS), comprising:
a communication unit determining a number of terminals by receiving the MBMS; and
a control unit determining a unit-cell or multi-cell transmission scheme by comparing predetermined unit-cell and multi-cell thresholds with the determined number of terminals.

14. The apparatus of claim 13, wherein
the communication unit
requests a reception intention for each MBMS through a broadcast channel and receives the reception intention through a feedback channel allocated to the terminal.

15. The apparatus of claim 13, wherein
the control unit
uses at least one of a control channel for notifying at least one of an identifier for each MBMS, data transmission time information, and positional information of a radio resource, a notice channel for determining the number of terminals or notifying a change of a predetermined notice, and a feedback channel for receiving feedback from the terminal.

16. The apparatus of claim 15, wherein
the control unit
determines a transmission scheme as the unit-cell transmission scheme when the number of terminals is smaller than the threshold or determines the transmission scheme as the multi-cell transmission scheme when the number of terminals is larger than the threshold.

17. The apparatus of claim 16, wherein
the control unit
retransmits data the predetermined number of times without allocating the common feedback channel when the number of terminals in each cell is larger than a frequency to use the feedback channel.

18. The apparatus of claim 17, wherein
the control unit
uses an L1/L2 control channel as the notice channel when error reporting is not provided from the terminal for a predetermined time.

19. The apparatus of claim 16, wherein
the control unit
does not multiplex the MBMS when the common feedback channel is used in the multi-cell transmission scheme and performs the multiplexing when the common feedback channel is not used.
